(19) United States
(12) Patent Application Publication
(10) Pub. No.: US 2012/0089937 A1
(43) Pub. Date: Apr. 12, 2012

(54) REMOTE CONTROLLER WITH TOUCH SCREEN

(75) Inventors: KUAN-HONG HSIEH, Tu-Cheng (TW); HAN-CHE WANG, Tu-Cheng (TW); CHIH-SAN CHIANG, Tu-Cheng (TW); HUA-DONG CHENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/076,447

(22) Filed: Mar. 31, 2011

(30) Foreign Application Priority Data
Oct. 8, 2010 (CN) 201010500007.1

(51) Int. Cl. G06F 3/048

(52) U.S. Cl. 715/773

(57) ABSTRACT

A remote controller with touch screen is used for controlling an electronic device. The remote controller includes a housing, a storage unit, an interface unit, and a processing unit. A remote control interface is displayed on the touch screen. The remote control interface includes at least one virtual key, and the at least one virtual key produces a corresponding trigger signal in response to user's touch. The processing unit identifies the remote code after receiving the trigger signal, and drives the interface unit to emit the corresponding coded pulse to the electronic device, and at the same time the processing unit drives the touch screen to display the next level remote control interface.

### BACKGROUND

1. Technical Field

The present disclosure relates to remote controllers and, particularly, to a remote controller with a touch screen.

2. Description of Related Art

Remote controllers generally provide buttons for user input, which limits the number of functions that can be satisfactorily controlled remotely when used with complex devices such as computers. To add more buttons would just overcomplicate the remote controllers.

### BRIEF DESCRIPTION OF THE DRAWINGS

The components of the drawings are not necessarily drawn to scale, the emphasis instead being placed upon clearly illustrating the principles of a remote controller with touch screen. Moreover, in the drawings, like reference numerals designate corresponding parts throughout several views.

FIG. 1 is a schematic diagram showing a remote controller and an electronic device controlled by the remote controller in a first use state, in accordance with an exemplary embodiment.

FIG. 2 is a block diagram of the remote controller of FIG. 1, in accordance with an exemplary embodiment.

FIG. 3 is a schematic diagram showing relationships between virtual keys and remote control codes of the remote controller of FIG. 1, and a logic tree illustrating hierarchal relationships among the virtual key in accordance with an exemplary embodiment.

FIG. 4 is a schematic diagram showing the remote controller and the electronic device of FIG. 1 in another use state, in accordance with an exemplary embodiment.

### DETAILED DESCRIPTION

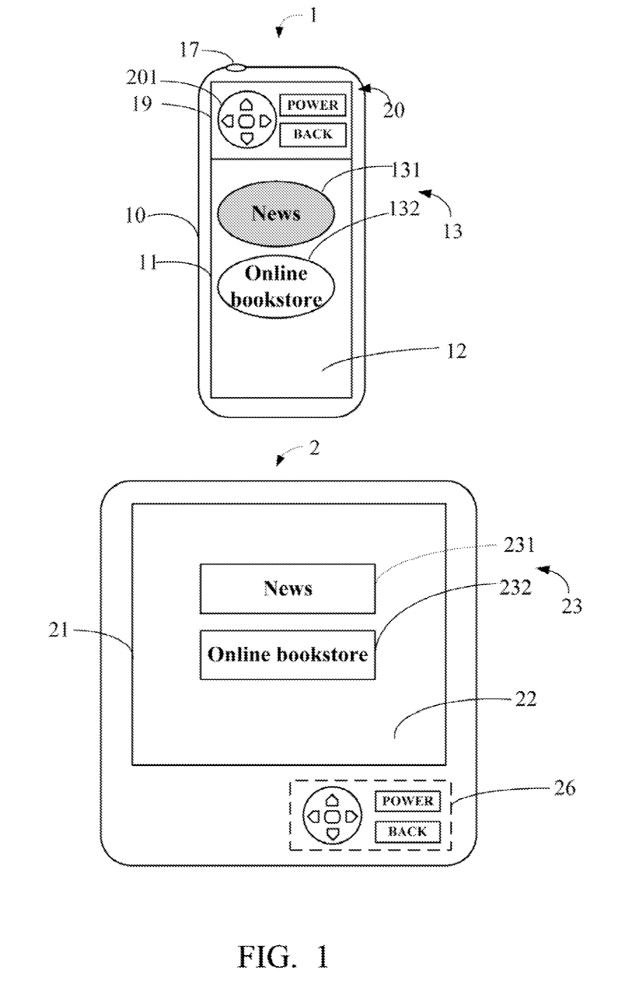

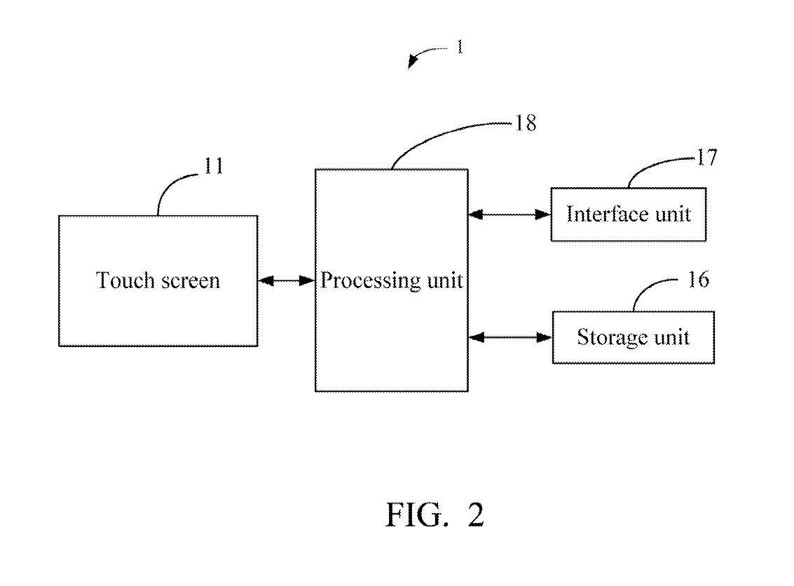

Referring to FIGS. 1-2, a remote controller 1 is used to control an electronic device 2. The electronic device 2 can be, for example, a digital photograph frame, a personal digital assistant (PDA), or an e-book.

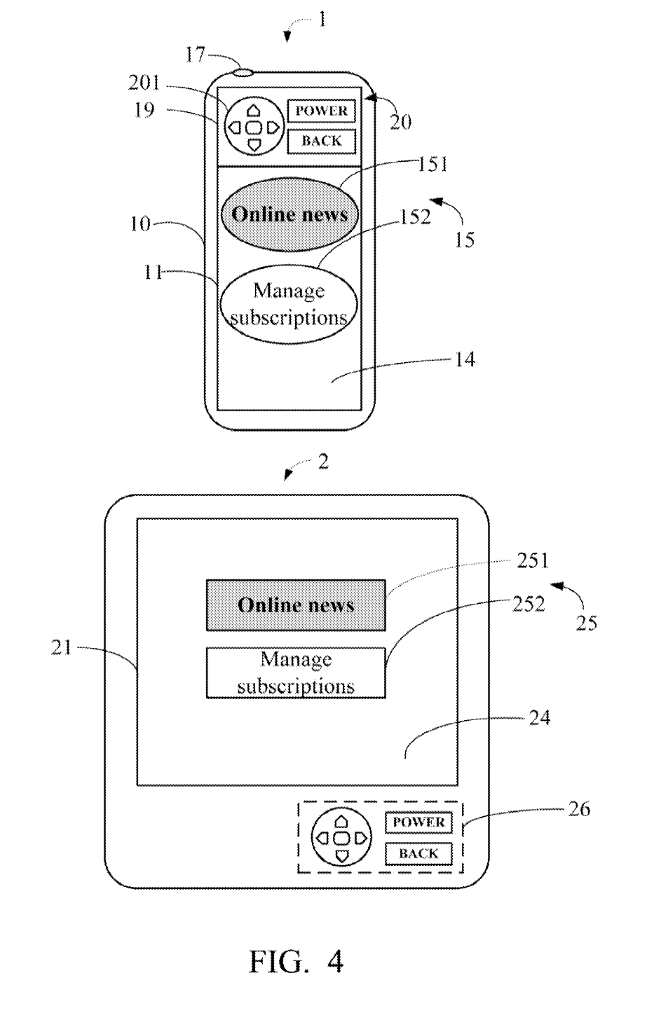

The electronic device 2 includes a display unit 20 configured for displaying information. The information includes at least one icon which is provided for the user to execute a function represented by the icon, for example, such as opening a next page of an electronic book. In this embodiment, the electronic device 2 displays two icons 22 including news icon 221 and online bookstore icon 222 on a current page. When the news icon 221 is selected, referring to FIG. 4, the display unit 20 displays corresponding information on a new page 23.

The remote controller 1 includes a housing 10, a touch screen 11, a storage unit 16, an interface unit 17, and a processing unit 18. The touch screen 11 displays a remote control interface for controlling the electronic device 2. The remote control interface includes at least one virtual key for producing a trigger signal in response to a user's touch.

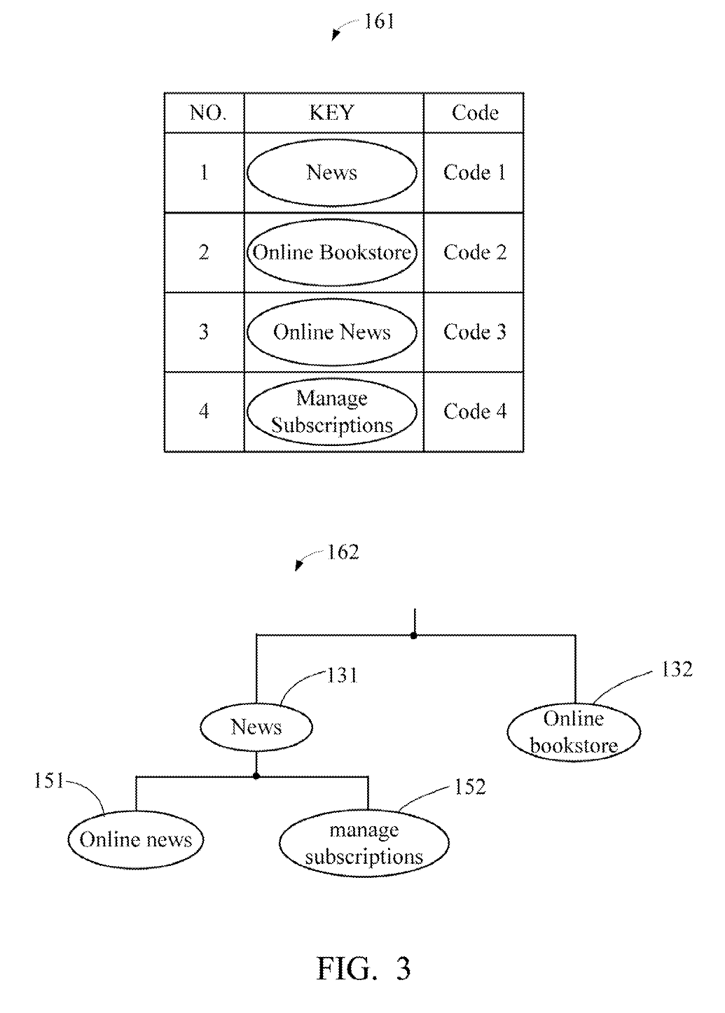

Referring to FIG. 3, the storage unit 16 stores a relationship list 161 and a logic tree 162. The relationship list 161 defines relationships between the virtual keys and remote control codes. The logic tree 162 defines relationships between multilevel remote control interfaces and the virtual keys displayed on each remote control interface. For example, referring to FIG. 1, in this embodiment, when the remote controller 1 displays an Nth level remote control interface 12, two corresponding virtual keys 13 are displayed on the remote control interface 12, and the virtual keys 13 are respectively labeled news key 131 and online bookstore key 132 with icons, according to the logic tree list 162.

The interface unit 17 is configured to emit a remote control code pulse, corresponding to the touched virtual key, to the electronic device 2. The interface unit 17 can be a wired USB interface, a wireless infrared interface, a BLUETOOTH interface, or a WiFi interface.

Referring to FIG. 3, for example, when the icons of the news key 131 and online bookstore key 132 are displayed on an Nth remote control interface 12, and the news key 131 icon is touched and outputs a trigger signal to the processing unit 18, the processing unit 18 identifies a remote code 1 corresponding to the virtual key 131 based on the relationship list 161, and then drives the interface unit 17 to emit a remote control pulse carrying the code 1 to the electronic device 2. The electronic device 2 receives the remote control pulse and then executes a corresponding function, which in this case is to display a next level page 23 including an online news icon 241 and a manage subscriptions icon 242. At the same time, the processing unit 18 drives the touch screen 11 of the remote controller 1 to also display the next level page 23 which includes corresponding virtual keys, online news icon 151 and manage subscriptions icon 152, based on the logic tree list 162. In an exemplary embodiment, the arrangement of the virtual keys is the same as that of the icons, namely, the position of the virtual keys displayed on the touch screen 11 is corresponding to that of each icon displayed on the electronic device 2. In other embodiment, the arrangement of the virtual is transformable, and different from that of the icons displayed on the electronic device 2.

In addition, when mechanical keys 25 are equipped on the electronic device 2, the remote controller 1 provides a predetermined area 19 to accommodate corresponding function keys. In this embodiment, the function keys include a five-direction key, a power key, and a back key. One of the mechanical keys which is togged transmit a corresponding remote control code to control the corresponding mechanical key 25 equipped on the electronic device 2 to execute corresponding function. In other embodiments, the predetermined area 19 can be a touch screen, and the function keys on the electronic device 2 are fixed virtual keys, or mechanical keys.

In an exemplary embodiment, when there is no icon on the currently displayed page of the electronic device 2, the remote control interface 12 also has no virtual key, and user can control the electronic device 2 by the function keys. For example, the back key and one of the mechanical keys 25 both can control the electronic device 2 to return to a previous page, and at the same time the processing unit 18 controls the touch screen 12 to display the previous remote control surface corresponding to the preceding page. It is to be understood, when a back icon is displayed on the display unit 20, a corresponding virtual back key also is displayed on the touch screen 11, and the function of the virtual back key is the same as the function of the back key.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A remote controller used for controlling an electronic device, comprising:
a housing;
a touch screen configured for displaying multilevel remote control interfaces, wherein each remote control interface includes at least one virtual key for producing a trigger signal when being touched;
a storage unit configured for storing a relationship list and a logic tree, wherein the relationship list defines relationships between the virtual keys and remote control codes, the logic tree defines relationships between the multilevel remote control interfaces and the at least one virtual key to be displayed on each remote control interface;
an interface unit configured for emitting a remote control code pulse, corresponding to the touched one of the at least one virtual key, to the electronic device;
a processing unit;
wherein, when the processing unit receives the trigger signal from the touched virtual key, it identifies a remote code according to the touched virtual key based on the relationship list, and drives the interface unit to emit a remote control code pulse to the electronic device, and drives the touch screen of the remote controller to display a next remote control surface based on the logic tree list.

2. The remote controller as claimed in claim 1, wherein the arrangement of the virtual keys is the same as that of the icons.

3. The remote controller as claimed in claim 1, wherein the arrangement of the virtual keys is different from that of corresponding icons

4. The remote controller as claimed in claim 1, wherein the interface unit is one selected from the group consisting a wired USB interface, a wireless infrared interface, a BLUETOOTH interface, and a WIFI interface.

5. The remote controller as claimed in claim 1, wherein when mechanical keys are equipped on the electronic device, the remote controller provides a predetermined area to accommodate corresponding function keys.

6. The remote controller as claimed in claim 5, wherein the predetermined area is a touch screen, and the keys are fixed virtual keys.

7. The remote controller as claimed in claim 5, wherein the function keys comprise a five-direction key, a power key, and a back key.
